(19) United States
(12) Patent Application Publication
(10) Pub. No.: US 2003/0046182 A1
(43) Pub. Date: Mar. 6, 2003

(54) System and method for providing articles electronically

(76) Inventor: Thomas H. Hartman, New York, NY (US)

Correspondence Address: KENYON & KENYON, 1500 K STREET, N.W., SUITE 700, WASHINGTON, DC, 20005, US

(21) Appl. No.: 10/096,680

(22) Filed: Mar. 14, 2002

Related U.S. Application Data
(60) Provisional application No. 60/315,956, filed on Aug. 31, 2001.

(51) Int. Cl. G06F 17/60

(52) U.S. Cl. 705/26

(57) ABSTRACT

A list of several publications is presented to the user, who makes a selection indicating one of the publications. A list of issues of the selected publication is presented to the user, who selects an issue. A table of contents of the selected issue is sent to the user, who selects an article listed in the table of contents. The user pays for the selected article. The selected article is sent to the user.

### FIELD OF THE INVENTION

The field of the invention is electronic publishing, and in particular flexibly providing content and content-finding services.

### RELATED APPLICATIONS

This application claims the benefit of U.S. Provisional Patent Application Serial No. 60/315,956, filed on Aug. 31, 2001.

### BRIEF DESCRIPTION OF THE DRAWINGS

FIG. 1 shows a system in accordance with an embodiment of the present invention.

FIG. 2 shows a system in accordance with another embodiment of the present invention.

FIG. 3 shows a flowchart of the method in accordance with an embodiment of the present invention.

### DETAILED DESCRIPTION

In accordance with an embodiment of the present invention called “PressSelect,” consumers can search, find and purchase for a fee individual articles from consumer and trade publishing sources, both online and offline. This can be achieved by displaying articles for sale from multiple publishers using one or more Tables of Contents as a navigation for the user, and/or by using search technology to find articles by topic, date, author, publication, etc. PressSelect can provide publishers with a service with which to sell their articles to consumers. The services described herein can be provided at a specialized PressSelect.com web site; on the web sites of those publishers that contract with PressSelect to provide its article selling service on their sites; or on other sites desiring to provide this content-selling service to their users.

PressSelect can take a multi-tiered approach to providing articles from a wide variety of publications to its users in multiple formats. A user can view Tables of Content from current or past issues of publications in the service; select the articles from these Tables of Content that a user wishes to purchase; purchase the articles; and download them. A user can search the PressSelect content database by providing keywords and attributing these to such fields as topic, date, author, etc., and then select, purchase and download the desired articles. A user can also advantageously create a “Personalized Magazine” using an embodiment of PressSelect to receive articles, or alerts about articles, about which the user has or is likely to have interest. The selection of articles sent to the user can be based upon preferences submitted by the user; upon user profile data gathered from the user during registration, or from some other source; advertiser promotions; etc. The personalized selected articles can be pushed to the user, i.e., sent to the user without an immediate request prompting the transmission; or pulled from a server by the user as the result of a specific request from the user to the server. For example, the selected articles can be sent to the user when the user “checks in” at the server.

PressSelect's database can collect and store TOC information such as article title, author, article summary, publication, issue date, etc. Users can examine tables of contents of publications included in the PressSelect service. When the user selects an article, PressSelect can manage a purchase of the selected article by the user, retrieve it, format it, and deliver the article to the user's viewing platform.

PressSelect can collect key information on each available article from each publication in the service. In cases in which PressSelect only stores representative data from a publication's articles, this data will be stored on PressSelect's servers. In other cases, PressSelect will store the entire text of the articles on its servers. In either case, the data can be searched by a user. A user can perform searches on this database using such items as author, title, subject, keyword, date, and publication The system can also provide full-text searches on the publications' articles. Finally, the articles that have been found can advantageously be converted to the appropriate formats and delivered to the user's viewing platform.

Using push or pull technology, registered users can select in advance search criteria that the system will use to review new content as it is added to the PressSelect database, e.g., as new issues of publications become available online. As the system identifies content that meets the criteria of the user, the system will present that content to the user for review and possible purchase. Some such content can be presented to the user at no charge.

PressSelect functions can be divided among different servers. For example, the e-commerce segment can be handled by a first server; the Tables of Content database can be on a second server; and the actual articles themselves can be on a third server. Each of these servers can be owned by different entities. For example, the first server can be owned by an e-commerce services company; the second server can be owned by a search service; and the third server can be owned by a publisher.

The results of searches and articles can be packaged for publication on a variety of devices and formats. PressSelect can support any suitable format, including HTML, XML, PDF, ASCII text, word processing formats, etc. The content can be delivered to any suitable platform, including personal computers, handheld mobile devices, etc. PressSelect users can advantageously select the device on which they wish to receive their purchased content.

The PressSelect user database can include registered users. User data can be collected at the time of registration, including a user's name; user identifier; password; address; e-mail; telephone number; credit card information; the names of publications and topics about which the user has requested PressSelect to send him/her alerts; etc. This information can advantageously be used to assess or anticipate the user's interests for selecting newly published articles to suggest to the user to buy, or else peruse at no charge. Users can be billed based on usage levels. Once a user has registered, the results of a search can be downloaded to the user's choice of receiving devices and paid for by means of choosing the duration of the search results (e.g., 1 session, 1 month, etc.), and by using the registered user's credit card information. Trial members may not have to provide credit card information, but can be required to provide contact and other pertinent information to obtain a trial subscription. PressSelect advantageously provides a variety of flexible billing plans, including purchasing individual or a group of articles; and annual, monthly, or other periodic plans. A user can check the status of a billing plan and modify user information through the PressSelect service.

The PressSelect web site can support advertising. Advertisements can advantageously be sent to the user that are targeted to the user, based upon information collected about the user at registration, and upon browsing, purchasing, and other online behavior of the user.

PressSelect can deliver, or arrange to have delivered, information on publications and articles over any suitable device and channel. For example, such information can be delivered over a wired or wireless connection, to a fixed user platform or any suitable mobile device.

PressSelect can include an alert system that alerts a user when the user is close to the end of his/her pre-paid access to the service—either the number of articles purchased or the period of a subscription—or when a new article becomes available that may be of interest to the user (e.g., meets the user's submitted search criteria for alerts); etc. The alert system can also be used to inform the user that an article of interest to the user has become newly available, and can provide the user with the opportunity to purchase the article, or else view it at no charge. Advertisements can also be sent over the alert system.

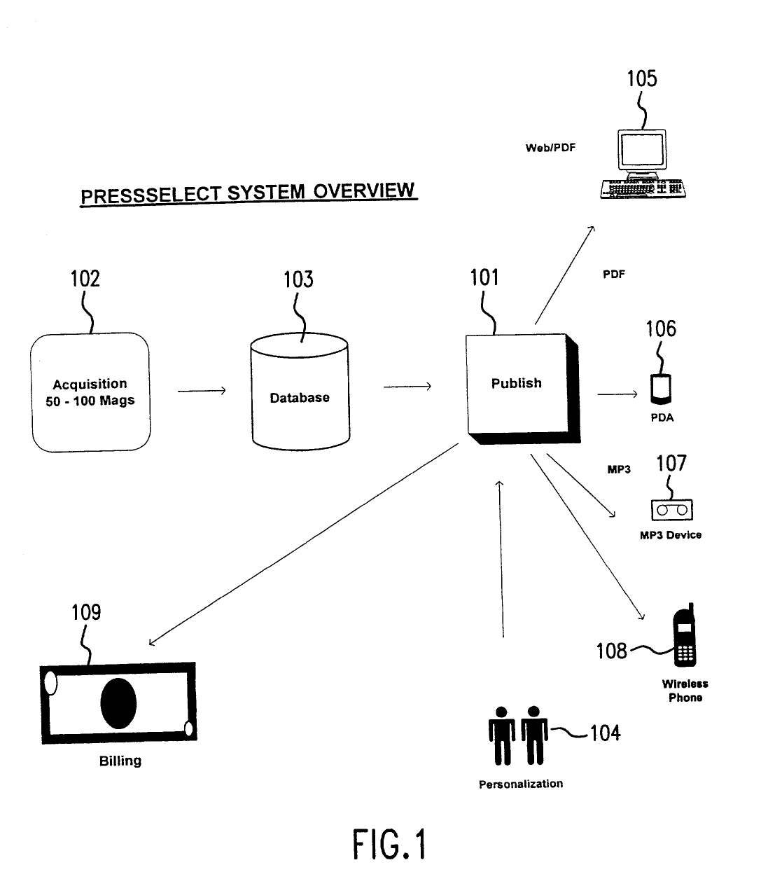

FIG. 1 shows a functional overview of a system in accordance with an embodiment of the present invention. The publishing component 101 acquires content from one or more publications 102 and stores the content and/or pointers to the content in a database 103. The system can personalize interfaces for particular users 104, such as by providing general or customized tables of content for particular publications in accordance with preferences expressed or derived from the users; by presenting a single, integrated, cross-publication master table of contents for a user in accordance with user preferences; etc. The interface and/or the requested content can be delivered via a variety of mechanisms, such as via Web/PDF 105; via Personal Digital Assistant (“PDA”) 106; to an MP3 device 107; and to a wireless device 108. Billing can be handled locally by the publishing component 101, or using an external billing service 109.

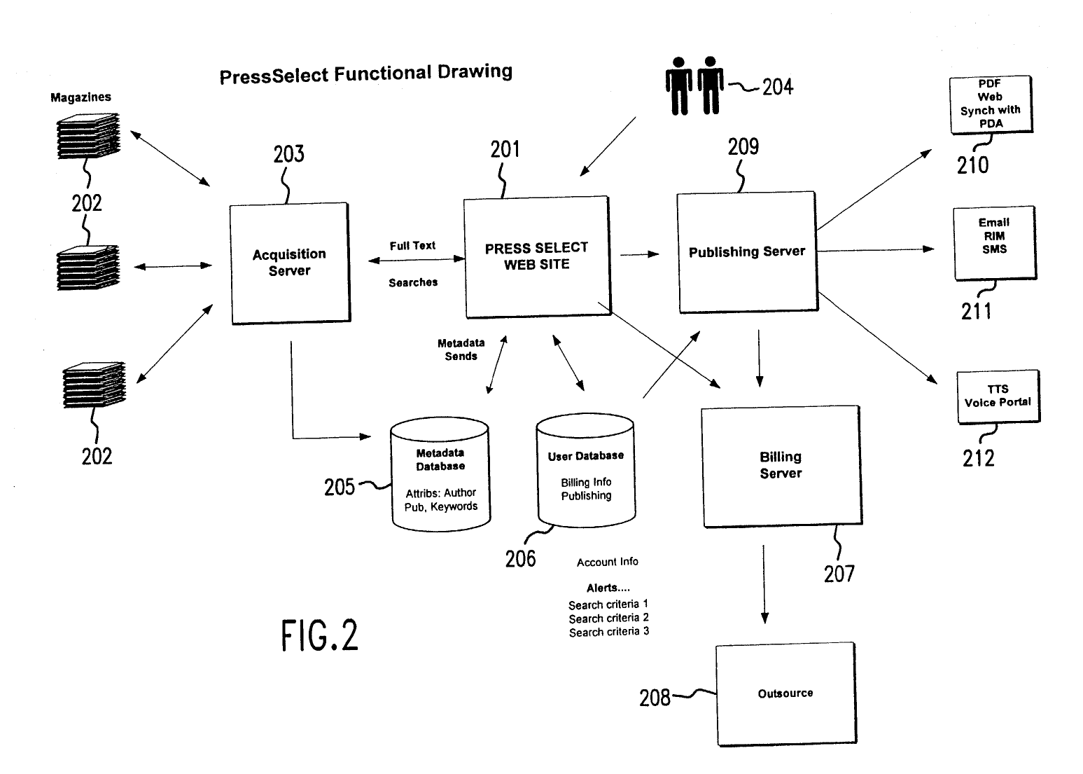

FIG. 2 shows an overview in accordance with another embodiment of the present invention. The PressSelect web site 201 acquires content from numerous publications 102 via acquisition server 203. Users 204 can search a database (such as the full text of the articles, or in formation about the articles in database 205) of the acquired content, and/or their search results can be passed on to external sites (e.g., content publisher sites) through acquisition server 203. In an embodiment, users 204 can also search user database 206 for billing and/or publishing information. User database 206 can also store alert criteria for sending alerts to users 204. The PressSelect web site 201 can also conduct commercial transactions for the purchase of content by users 204, and interface with billing server 207. Billing server 207 can handle billing internally (e.g., by establishing user accounts and sending invoices, by accepting e-cash, etc.) or outsource 208 the billing function. Content delivery can be handled by publishing server 209, which can send content over any appropriate path to any suitable device, including email, Click-and-View, PDF over the web via a synchronization conducted using a PDA 210; e-mail using RIM or Short Message Service (“SMS”) 211; and/or Text-to-Speech (“TTS”) using a voice portal 212.

An embodiment of the present invention can be implemented on hardware that includes a processor coupled to memory. The processor can be a general purpose processor, such as an Intel Pentium IV; an Application Specific Integrated Circuit (“ASIC”) that embodies at least a part of the method of an embodiment of the present invention in hardware and/or firmware; or a combination thereof. Memory can be any suitable device for storing digital information, such as Random Access Memory (“RAM”); Read Only Memory (“ROM”); a hard disk; a CD-ROM; etc. Memory stores instructions adapted to be executed by the processor to perform the method in accordance with an embodiment of the present invention. For example, memory stores PressSelect instructions adapted to be executed by the processor to send a list of a plurality of publications; receive a selection indicating a publication; send a list of issues of a selected publication; receive a selection of an issue of the selected publication; send a table of contents of the selected issue; receive a selection of an article in the table of contents; and send the selected article to the user. All or a part of these PressSelect instructions can also be stored on a portable memory device for sale [don't get this, but assume you do](e.g., on a CD-ROM), or sent over a network to a recipient, e.g., via File Transfer Protocol (“FTP”).

As discussed above, PressSelect can advantageously be implemented on a publisher's own site, providing users with the ability to purchase articles from the publisher from Tables of Content or from searches of the publisher's content. When the user selects an article in the table of contents, the user can be sent a link along with further information about the article, such as a summary. The user can be informed that the article may be purchased for a given price by selecting the link. If the user selects the link, then the users can be charged and the article can be presented to the user.

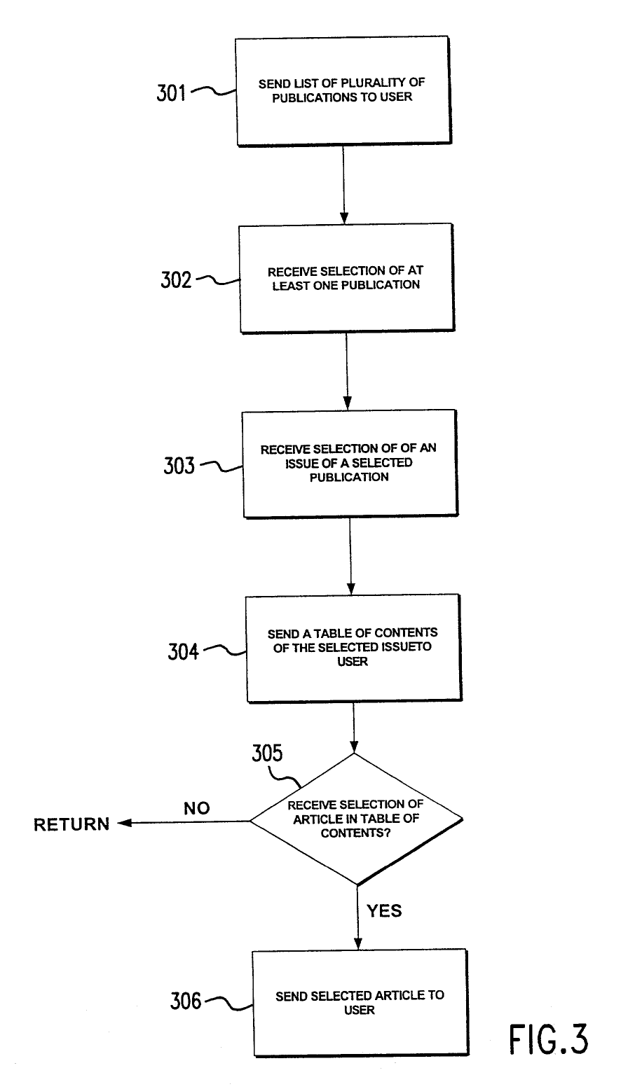

FIG. 3 is a flow chart showing the method in accordance with an embodiment of the present invention. A list of a plurality of publications is sent to the user, step 301. As used herein, the term “list” is meant to include any representation of a plurality of items. A selection indicating at least one of the publications is received, step 302. A selection of an issue of a selected publication is received, step 303. The issue can be selected from a list of issues that can be sent to the user with the list of publications, or in response to the selection of at least one publication. A table of contents of the selected issue is sent for presentation to the user, step 304. If a user selection of an article in the table of contents is received, step 305, then the selected article is sent to the user, step 306.

The foregoing description is meant to illustrate, and not limit, the scope of the present invention. Any person of ordinary skill in the art will recognize other embodiments of the present invention, which are meant to be encompassed by this description. For example, numerous equivalent architectures may be used to implement embodiments of the present invention over a variety of networks, including the Internet, a Local Area Network, a Wide Area Network, etc. Further, several embodiments for representing the Table of Contents by which a user navigates available articles are encompassed by this description. For example, Tables of Contents for different publications can be selected and browsed by the user, from which the user can select articles for purchase. Likewise, the user can indicate one or more topics by which to organize a single Table of Contents across publications, from which the user may select articles for purchase. Known keyword and full text search functionality can be provided to assist the user in locating publications, Tables of Content, articles for purchase, etc. Also, a link to the article can be sent rather than the article itself, such that the link must be selected by the user to purchase the article. When the link is selected, the article is delivered and the user is charged for the article. Or a user can be sent the Table of Contents from a given issue of a given publication and select from that TOC the articles that the user wishes to purchase, without ever visiting the publication's website.

What is claimed is:

1. A method for distributing an article, including:
sending a list of a plurality of publications;
receiving a selection indicating a publication;
receiving a selection indicating an issue of the selected publication;
sending a table of contents of the selected issue;
receiving a selection of an article in the table of contents; and
sending the selected article to the user.

2. The method of claim 1, further including charging the user if the copy of the article is sent to the user.

3. The method of claim 1, wherein the article is sent to the user by e-mail.

4. The method of claim 1, wherein the article is sent to the user by HyperText Transfer Protocol.

5. The method of claim 1, wherein at least one of the publications is a periodical publication.

6. The method of claim 1, further including receiving a search term from a user;
searching for articles that correspond to the search term;
sending to the user a list of articles that correspond to the search term;
receiving a selection of an article on the list;
sending a copy of the selected article to the user.

7. The method of claim 6, further including charging the user if the article is sent to the user.

8. A method for distributing articles, including:
receiving a preference from a user;
selecting an article that corresponds to the preference;
sending an article link to the user; and
if the user selects the link, then sending the article to the user.

9. The method of claim 8, further including sending a summary of the article to the user along with the link.

10. The method of claim 8, further including charging the user if the copy of the article is sent to the user.

11. The method of claim 8, wherein the preference includes a topic identifier.

12. The method of claim 8, wherein the preference includes an author name.

13. The method of claim 8, wherein the preference includes a publication name.

14. The method of claim 8, wherein the preference includes a keyword.

15. A method for distributing articles, including:
receiving a preference from a user to receive a table of contents of an issue of a publication;
sending the user the table of contents;
receiving a selection of an article in the table of contents;
sending a copy of the selected article to the user.

16. The method of claim 15, further including charging the user if the copy of the article is sent to the user.

17. The method of claim 15, wherein the article is sent to the user by e-mail.

18. The method of claim 15, wherein the article is sent to the user by HyperText Transfer Protocol.

19. The method of claim 15, wherein the preference includes a topic identifier.

20. The method of claim 15, wherein the preference includes an author name.

21. The method of claim 15, wherein the preference includes a publication name.

22. The method of claim 15, wherein the preference includes a keyword.

23. A method for distributing an article, including:
sending a list of a plurality of publications;
receiving a selection indicating a publication;
sending a list of issues of the selected publication;
receiving a selection indicating an issue of the selected publication;
sending a table of contents of the selected issue;
receiving a selection of an article in the table of contents; and
sending the selected article to the user.

24. A method for distributing articles, including:
receiving a preference from a user;
selecting an article that corresponds to the preference;
sending an article link to the user; and
if the user selects the link, then sending a copy of the article to the user.

25. A method for distributing articles, including:
receiving a preference from a user to receive a table of contents of the current issue of a publication;
sending the user the table of contents;
receiving a selection of an article in the table of contents;
sending a copy of the selected article to the user.
